(19) United States
(12) Patent Application Publication
(10) Pub. No.: US 2022/0108217 A1
(43) Pub. Date: Apr. 7, 2022

(54) MODEL LEARNING APPARATUS, LABEL ESTIMATION APPARATUS, METHOD AND PROGRAM THEREOF

(71) Applicant: NIPPON TELEGRAPH AND TELEPHONE CORPORATION, Tokyo (JP)

(72) Inventors: Hosana KAMIYAMA, Tokyo (JP); Satoshi KOBASHIKAWA, Tokyo (JP); Atsushi ANDO, Tokyo (JP); Ryo MASUMURA, Tokyo (JP)

(73) Assignee: NIPPON TELEGRAPH AND TELEPHONE CORPORATION, Tokyo (JP)

(21) Appl. No.: 17/429,875

(22) PCT Filed: Jan. 29, 2020
(86) PCT No.: PCT/JP2020/003061

§ 371 Date: Aug. 10, 2021

(30) Foreign Application Priority Data
Feb. 12, 2019 (JP) 2019-022353

(51) Int. Cl. G06N 20/00; G06K 9/62; G10L 15/06; G10L 15/065

(52) U.S. Cl. CPC G06N 20/00; G06K 9/6296; G10L 2015/0631; G10L 15/063; G10L 15/065; G06K 9/6257

(57) ABSTRACT

A model capable of estimating a label with high accuracy is learned even when training data involving a small number of raters per data item is used. Learning processing is performed in which a plurality of data items and label expectation values that are indicators representing degrees of correctness of individual labels on the data items are used in pairs as training data, and a model that estimates a label on an input data item is obtained.

### TECHNICAL FIELD

The present invention relates to model learning and label estimation.

### BACKGROUND ART

In a test that assesses conversation skill by rating an impression such as likability of telephone voices (Non-Patent Literature 1) or pronunciation proficiency and fluency of a foreign language (Non-Patent Literature 2), quantitative impression values (for example, five-level ratings ranging from, “good” to “bad”, five-level ratings of likability ranging from “high” to “low”, five-level ratings of naturalness ranging from “high” to “low”, or the like) are assigned to voices.

Currently, experts in each skill perform pass/fail determination by rating an impression of a voice and assigning an impression value. However, if an impression value can be obtained by automatically estimating an impression of a voice, such impression values can be utilized in score-based rejection determination or the like in a test, or can be used as reference values for an expert who is inexperienced at rating (for example, a person who has recently become a rater).

To realize automatic estimation of a label (for example, an impression value) on data (for example, voice data) by using machine learning, a model that estimates a label on input data may be generated by performing learning processing in which data and labels assigned to the data are used in pairs as training data.

However, there are individual differences among raters, and a rater who is inexperienced at assigning a label may assign a label to data in some cases.

Accordingly, different raters may assign different labels to the same data in some cases.

To learn a model that estimates a label seeming like an average of values of labels assigned by a plurality of raters, a plurality of raters may assign labels to the same data, and a pair of a label obtained by averaging values of the labels and the data may be used as training data. To be able to stably estimate average labels, as many raters as possible may assign labels to the same data. For example, in Non-Patent Literature 3, ten raters assign labels to the same data.

### CITATION LIST

### Non-Patent Literature

Non-Patent Literature 1: F. Burkhardt, B. Schuller, B. Weiss and F. Weninger, “Would You Buy a Car From Me?” On the Likability of Telephone Voices,” In Proc. Interspeech, pp. 1557-1560, 2011.

Non-Patent Literature 2: Kei Ohta and Seiichi Nakagawa, “A statistical method of evaluating pronunciation proficiency for Japanese words,” INTERSPEECH2005, pp. 2233-2236.

Non-Patent Literature 3: Takayuki Kagomiya, Kenji Yamasumi and Yoichi Maki, “Overview of impression rating data,” [online], [retrieved on Jan. 28, 2019], Internet <http: //pj.ninjal.ac.jp/corpus_center/csj/manu-f/impression.pdf>

### SUMMARY OF THE INVENTION

Technical Problem

There are persons with strong ability in rating and persons without such ability among raters. When there are many raters per data item, labels on training data are corrected to be correct ones to some extent, owing to labels assigned by raters with strong ability in rating even if raters with low ability in rating are among the raters. However, when the number of raters per data item is small, errors of labels on training data become so significant due to lack of ability of raters in rating that a model that estimates a label with high accuracy cannot be learned in some cases.

The present invention has been made in view of such respects, and provides a technique that can learn a model capable of estimating a label with high accuracy even when training data involving a small number of raters per data item is used.

### Means for Solving the Problem

In the present invention, learning processing is performed in which a plurality of data items and label expectation values that are indicators representing degrees of correctness of individual labels on the data items are used in pairs as training data, and a model that estimates a label on an input data item is obtained.

### Effects of the Invention

In the present invention, since a plurality of data items and label expectation values are used in pairs as training data, a model capable of estimating a label with high accuracy can be learned even when the number of raters per data item is small.

### BRIEF DESCRIPTION OF DRAWINGS

FIG. 1 is a block diagram illustrating a functional configuration of a model learning device in a first embodiment.

FIG. 2 is a flowchart for illustrating a model learning method in the first embodiment.

FIG. 3 is a block diagram illustrating a functional configuration of a label estimation device in the embodiment.

FIG. 4 is a diagram for illustrating training label data in the embodiment.

FIG. 5 is a diagram for illustrating training feature data in the embodiment.

FIG. 6 is a block diagram illustrating a functional configuration of a model learning device in a second embodiment.

FIG. 7 is a flowchart for illustrating a model learning method in the second embodiment.

FIG. 8 is a diagram for illustrating label expectation values estimated in the first and second embodiments.

### DESCRIPTION OF EMBODIMENTS

Hereinafter, embodiments of the present invention will be described with reference to drawings.

### First Embodiment

First, a first embodiment of the present invention will be described.

<Configuration>

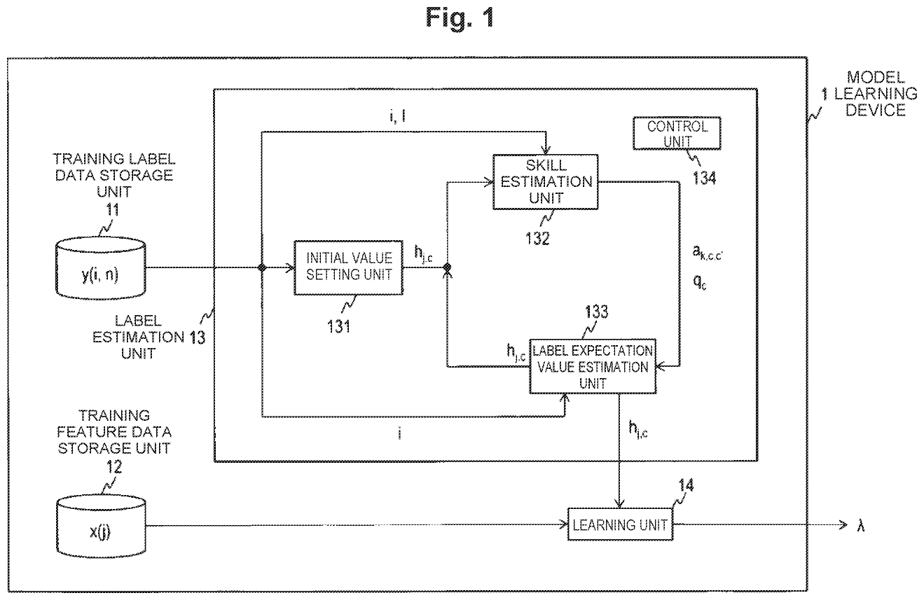

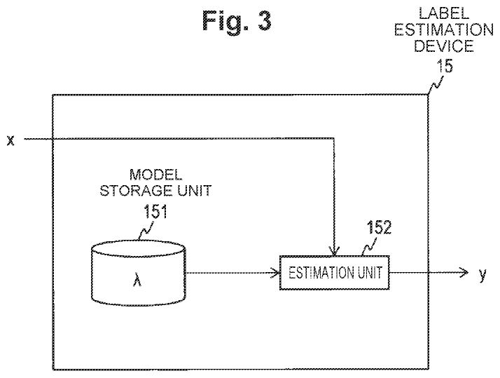

As illustrated in FIG. 1, a model learning device 1 in the present embodiment includes a training label data storage unit 11, a training feature data storage unit 12, a label estimation unit 13, and a learning unit 14. The label estimation unit 13 includes an initial value setting unit 131, a skill estimation unit 132, a label expectation value estimation unit 133, and a control unit 134. As illustrated in FIG. 3, a label estimation device 15 in the present embodiment includes a model storage unit 151 and an estimation unit 152.

<Preprocessing>

As preprocessing of model learning processing by the model learning device 1, training label data is stored in the training label data storage unit 11, and training feature data is stored in the storage unit 12. The training label data is information representing impression value labels (labels) assigned by a plurality of raters, respectively, to each of a plurality of training feature data items (data items). The training feature data may be data representing human perceptible information (for example, voice data, music data, text data, image data, video data, or the like), or may be data representing feature amounts of such human perceptible information. An impression value label is a correct label assigned to a training feature data item by a rater based on own determination after the rater perceives “human perceptible information (for example, voice, music, text, an image, video, or the like)” corresponding to the training feature data item. For example, an impression value label is a numerical value representing a rating result (for example, a numerical value representing an impression) assigned by a rater who perceives “human perceptible information” corresponding to a training feature data item after the rater rates the information.

<<Illustration of Training Label Data and Training Feature Data>>

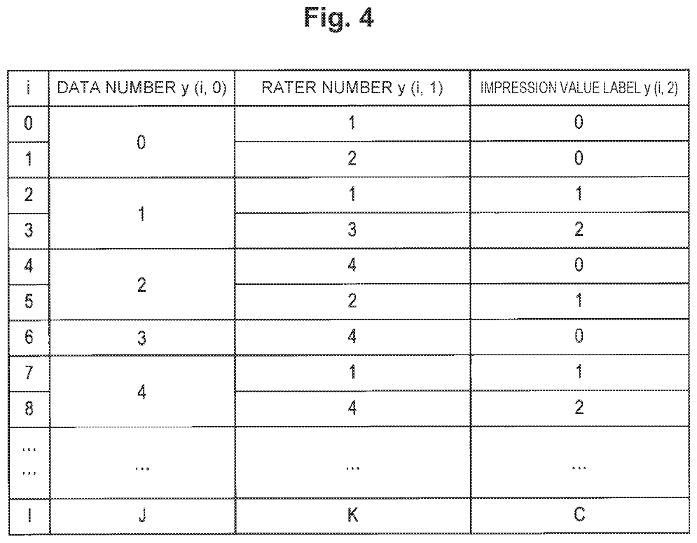

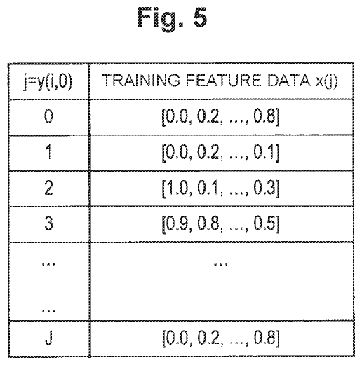

An example of the training label data is shown in FIG. 4, and an example of the training feature data is shown in FIG. 5. However, the examples are shown for illustrative purposes and do not limit the present invention.

The training label data illustrated in FIG. 4 has a label data number i, a data number y(i, 0), a rater number y(i, 1), and an impression value label y(i, 2) (label) that corresponds to a correct label (for example, that is a correct label). Here, the label data number i ∈{0, 1, 1} is a number that identifies each record in the training label data. The data number y(i, 0)∈{0, 1, . . . , J} is a number that identifies each training feature data item. The rater number y(i, 1)∈{0, 1, . . . , K} is a number that identifies each rater who rates information (human perceptible information; for example, voice) corresponding to a training feature data item. The impression value label y(i, 2)∈{0, 1, . . . , C} is a numerical value representing a result of rating, by a rater, of information (human perceptible information; for example, voice) corresponding to a training feature data item. For example, an impression value label y(i, 2) with a larger value may indicate a higher rating, or conversely, an impression value label y(i, 2) with a smaller value may indicate a higher rating. Each of I, J, K, C is an integer equal to or larger than two. In the example in FIG. 4, each label data number i is associated with a data number y(i, 0), a rater number y(i, 1), and an impression value label y(i, 2), which are described next. Here, the data number y(i, 0) identifies a rating-target training feature data item. The rater number y(i, 1) identifies a rater who has rated the training feature data item with the data number y(i, 0). The impression value label y(i, 2) represents a result of rating performed by the rater with the rater number y(i, 1) on the training feature data item with the data number y(i, 0). As illustrated in FIG. 4, it is assumed that in at least part of the training feature data, a plurality of impression value labels y(i, 2) are assigned to one training feature data item by a plurality of raters. In the example in FIG. 5, each of a plurality of the data numbers j=y(i, 0)∈{0, 1, . . . , J} is associated with a training feature data item x(j) with the data number j. Each training feature data item x(j) in the example in FIG. 5 is feature amounts of a vector or the like including, as elements, voice signals or features extracted from a voice signal.

<Model Learning Processing>

Next, model learning processing in the present embodiment will be described

<<Processing by the Label Estimation Unit 13>>

Processing by the label estimation unit 13 in the model learning device 1 (FIG. 1) will be described.

Abilities of raters to correctly assign a label to data are not uniform, and differ from rater to rater in some cases. The label estimation unit 13 estimates an ability of a rater to correctly assign a label to data, and a degree of correctness of each label on the data. In other words, the label estimation unit 13 receives information representing labels (training label data) as input and outputs indicators representing degrees of correctness of the individual labels as label expectation values, by performing first processing and second processing, which are described in detail below. The training label data is information representing labels assigned by a plurality of raters, respectively, to each of a plurality of data items. The first processing updates indicators representing abilities of the raters to correctly assign the labels to the data items. In the first processing, it is regarded that the indicators representing degrees of correctness of the individual labels (impression value labels) on the data items (training feature data) are known. In other words, the indicators representing degrees of correctness of the individual labels on the data items are regarded as accurate. The second processing updates the indicators representing degrees of correctness of the individual labels on the data items. Here, it is regarded that the indicators representing abilities of the raters to correctly assign the labels to the data items are known. In other words, the indicators representing abilities of the raters to correctly assign the labels to the data items are regarded as accurate. The label estimation unit 13 iterates the first, processing and the second processing alternately, and outputs the indicators representing degrees of correctness of the individual labels on the data items obtained through the processing as label expectation values. The iterative processing of the first processing and the second processing is performed, for example, in accordance with an algorithm that estimates a solution while obtaining a latent variable. The obtained label expectation values are transmitted to the learning unit 14.

In the present embodiment, a case in which following (1-a) to (1-d) are satisfied will be illustrated as an example. However, such a case does not limit the present invention.

(1-a) Each of the “indicators representing degrees of correctness of the individual labels on the data items” is a probability h_{j,c} that an impression value label c=y(i, 2)∈{0, 1, . . . , C} on a data number j=y(i, 0)∈{0, 1, . . . , J} is a true label (correct impression value label) (a probability that each label c on a data item j is a true label).

(1-b) Each of the “indicators representing abilities of the raters to correctly assign the labels to the data items” is a probability a_{k,c,c′} that a rater with a rater number k=y(i, 1) assigns an impression value label c′∈{0, 1, . . . , C} to information (human perceptible information; for example, voice) with a data number j=y(i, 0) whose true impression value label is c∈{0, 1, . . . , C} (a probability that a rater k assigns a label c′ to a data item j with a true label c).

(1-c) The “first processing” is processing of updating the probability a_{k,c,c′} and a distribution q_{c} of the individual labels c∈{0, 1, . . . , C}, by using the probability h_{j,c}.

(1-d) The “second processing” is processing of updating the probability h_{j,c}, by using the probability a_{k,c,c′} and the distribution q_{c}.

The label estimation unit 13 in the example estimates the probability a_{k,c,c′} and the distribution q_{c} and estimates the probability h_{j,c} alternately through an EM algorithm, and, with respect to each j∈{0, 1, . . . , J} and each c∈{0, 1, . . . , C}, outputs the optimum probability h_{j,c} as label expectation values to the learning unit 14. Here, sets A (α, β, γ) including records of the training label data, and the number N(α, β, γ) of records belonging to each set A(α, β, γ) are defined as follows, by using the data number j∈{0, 1, . . . , J}, the rater number k∈{0, 1, . . . , K}, and the impression value label c∈{0, 1, . . . , C}.

A(j, k, c)={i|y(i, 0)=j\hat{ }y(i, 1)=k\hat{ }y(i, 2)=c, ∀i}
N(j, k, c)=|A(j, k, c)|
A (*, k, c)={i|y(i, 1)=k\hat{ }y(i, 2)=c, ∀i}
N(*, k, c)=|A (*, k, c)|
A(j, *, c)={i|y(i, 0)=j\hat{ }y(i, 2)=c, ∀i}
N(j, *, c)=|A(j, *, c)|
A(j, k, *)={i|y(i, 0)=j\hat{ }y(i, 1)=k, ∀i}

### N(j, k, *)=|A(j, k, *)|

A(j, *, *)={i|y(i, 0)=j, ∀i}

### N(j, *, *)=|A (j, *, *)|

A(*, k, *)={i|y(i, 1)=k, ∀i}

### N(*, k, *)=|A(*, k, *)|

A (*, *, c)={i|y(i, 2)=c, ∀i}
N(*, *, c)=|A(*, *, c)|
A=A(*, *, *)={∀i}

### N=N (*, *, *)=|A(*, *, *)|=I+1

where * is a symbol indicating any number. |α| for a set α represents the number of elements belonging to the set α.

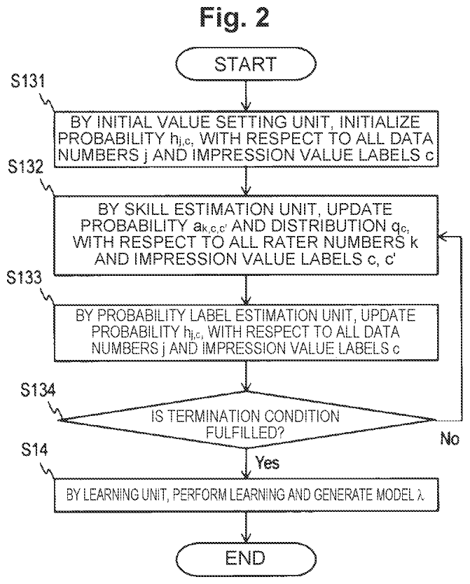

Details of the processing by the label estimation unit 13 will be described by using FIG. 2.

<<Step S131>>

The initial value setting unit 131 (FIG. 1) of the label estimation unit 13 refers to training label data (FIG. 4) stored in the training label data storage unit 11, and, with respect to all data numbers j∈{0, 1, . . . , J} and all impression value labels c∈{0, 1, C}, sets initial values of (initializes) the probability h_{j,c} and outputs the initial values of the probability h_{j,c}. Although a method for setting initial values of the probability h_{j,c} is not particularly limited, the initial value setting unit 131 sets initial values of the probability h_{j,c}, for example, as follows.

$$\begin{matrix}[ Math . 1 ] & \\ {h}_{j , c} = \frac{N ( j , * , c )}{N ( j , * , *)} & ( 1 )\end{matrix}$$

The initial values of the probability h_{j,c} outputted from the initial value setting unit 131 are transmitted to the skill estimation unit 132.

<<Step S132>>

The skill estimation unit 132 receives the newest probability h_{j,c} as input, and estimates (updates) and outputs the probability a_{k,c,c′} according to Expression (2) below. In other words, the skill estimation unit 132 regards the probability h_{j,c} as known (accurate), and updates and outputs the probability a_{k,c,c′}, according to Expression (2).

$$\begin{matrix}[ Math . 2 ] & \\ {a}_{k , c , {c}^{′}} = \frac{{\sum }_{i ∈ A (* , k , {c}^{′} )} {h}_{y ( i , 0 ) , c}}{{\sum }_{i ∈ A (* , k , *)} {h}_{y ( i , 0 ) , c}} & ( 2 )\end{matrix}$$

Moreover, the skill estimation unit 132 estimates (updates) and outputs the distribution (probability distribution) q_{c} of all impression value labels c∈{0, 1, . . . , C}, according to Expression (3) below. In other words, the skill estimation unit 132 regards the probability h_{j,c} as known (accurate), and updates and outputs the distribution q_{c}, according to Expression (3).

$$\begin{matrix}[ Math . 3 ] & \\ {q}_{c} = \frac{{\sum }_{i ∈ A (* , * , c )} {h}_{y ( i , 0 ) , c}}{N} & ( 3 )\end{matrix}$$

The new probability a_{k,c,c′} and the new distribution q_{c} updated by the skill estimation unit 132 are transmitted to the label expectation value estimation unit 133.

<<Step S133>>.

The label expectation value estimation unit 133 receives the newest probability a_{k,c,c′} and the newest distribution q_{c} as input, and, with respect to all data numbers j∈{0, 1, . . . , J} and all impression value labels e∈{0, 1, . . . , C}, estimates (updates) and outputs the Probability h_{j,c}, according to Expressions (4) and (5) below. In other words, the label expectation value estimation unit 133 regards the probability a_{k,c,c′} and the distribution q_{c} as known (accurate), and updates and outputs the probability h_{j,c}, according to Expressions (4) and (5).

$$\begin{matrix}[ Math . 4 ] & \\ {Q}_{j , c} = {q}_{c} {\prod }_{i ∈ A ( j , * , c )} {a}_{y ( i , 1 ) , c , y ( i , 2 )} & ( 4 ) \\ [ Math . 5 ] & \\ {h}_{j , c} = \frac{{Q}_{j , c}}{{\sum }_{{c}^{′}} {Q}_{j , {c}^{′}}} & ( 5 )\end{matrix}$$

The new probability h_{j,c} updated by the label expectation value estimation unit 133 is transmitted to the skill estimation unit 132.

<<Step S134>>

The control unit 134 determines whether or not a termination condition is fulfilled. The termination condition is not limited, and any condition may be used for the termination condition as long as it can be determined that the probability h_{j,c} has converged to a necessary level. For example, the control unit 134 may determine that the termination condition is fulfilled when a difference Δh_{j,c} between the probability h_{j,c} updated through the latest processing in step S133 and the previous probability h_{j,c} immediately before the update is below a preset positive threshold value δ(Δh_{j,c}<δ) with respect to all data numbers j∈{0, 1, . . . , J} and all impression value labels c∈{0, 1, . . . , C}. Alternatively, the control unit 134 may determine that the termination condition is fulfilled when the number of iterations of steps S132 and S133 exceeds a threshold value. When it is determined that the termination condition is not fulfilled, the processing returns to step 3132. When it is determined that the termination condition is fulfilled, the label expectation value estimation unit 133 outputs the newest probability h_{j,c} as label expectation values to the learning unit 14, and the learning unit 14 performs processing in step S14, which is described below.

<<Processing by the learning unit. 14>>

<<Step S14>>

With respect to all data numbers j∈{0, 1, . . . , J} and all impression value labels c∈{0, 1, . . . , C}, the learning unit 14 performs processing of learning training data as described below, and obtains and outputs information (for example, model parameters) specifying a model λ that estimates an impression value label on an input data item x. Here, for the training data, the training feature data items x(j) (a plurality of data items) read from the training feature data storage unit 12 and the label expectation values (probability) h_{j,c}, (label expectation values that are the indicators representing degrees of correctness of the individual labels on the data items) transmitted from the label expectation value estimation unit 133 are used in pairs. The input data item x is data of the same type as the training feature data items x(j) and is, for example, data in the same format as the training feature data items x(j).

A type of the learning processing performed by the learning unit 14 and a type of the model λ obtained through the learning processing are not limited. For example, when the model λ is a neural network model, the learning unit 14 may perform learning such that a cross-entropy loss will be minimized. For example, the learning unit 14 may obtain the model λ by performing learning such that a cross-entropy, loss expressed as Expression (6) below will be minimized.

$$\begin{matrix}[ Math . 6 ] & \\ E = - {\sum }_{j = 0}^{J} {\sum }_{c = 0}^{C} {h}_{j , c} log \hat{y} ( j ) & ( 6 )\end{matrix}$$

where y\hat{ }(j) is an estimation value of a neural network model for x(j), y\hat{ }(j)=f(x(j)), where f is the model λ. The learning unit 14 obtains the model λ by updating f such that the cross-entropy loss will be minimized. Note that a superscript “\hat{ }” in y\hat{ }(j) would have been written in situ directly above “y” as in Expression (6), but “\hat{ }” is written right above “y” due to presentation constraints. The model λ may be a recognition model such as SVM (support vector machine). For example, when the model λ is an SVM, the learning unit 14 learns parameters of the model λ, as described below. Here, the learning unit 14 generates (C+1) training feature data items x(j) from each training feature data item x(j) read from the training feature data storage unit 12, with respect to all data numbers j∈{0, 1, . . . , J}. The learning unit 14 then uses the training feature data items x(j), the impression value labels c, and the label expectation values h_{j,c} serving as sample weights in combinations (x(j), 0, h__{j,0}), (x(j), 1, h__{j,1}), . . . , x(j), C, h__{j,c}) as training data, and learns parameters of the model λ on a basis of finding a maximum-margin hyperplane that maximizes distances between each training data point. Note that the label expectation values h_{j,c} correspond to sample weights for the SVM.

<Estimation processing>

Next, estimation processing in the present embodiment will be described.

The information specifying the model λ outputted from the model learning device 1 as described above is stored in the model storage unit 151 of the label estimation device 15 (FIG. 3). An input data item x of the same type as the above-described training feature data items x(j) is inputted into the estimation unit 152. The estimation unit 152 reads the information specifying the model λ from the model storage unit 151, applies the input data item x to the model λ, and estimates and outputs a label y on the input data item x. For one input data item x, the estimation unit 152 may output one label y, may output a plurality of labels y, or may output probabilities of a plurality of labels y.

### Second Embodiment

Next, a second embodiment of the present invention will be described. In the following, a description will be Given mainly of different points from the matters already described, and a description of the matters already described is simplified by using the same reference numerals.

In the first embodiment, using the EM algorithm, the probability h_{j,c} that is “indicators representing degrees of correctness of the individual labels on the data items” and the probability a_{k,c,c′} that is “indicators representing abilities of the raters to correctly assign the labels to the data items” are alternately estimated, and the optimum probability h_{j,c} is obtained as label expectation values, with respect to each j∈{0, 1, . . . , J} and each c∈{0, 1, . . . , C}. However, when there are a small number of impression value labels y(i, 2) per data number y(i, 0) (that is, per training feature data item), the probability h_{j,c} or the probability a_{k, c,c′} may abruptly fall into local solutions during the above-described process of estimation, and appropriate label expectation values to be originally obtained cannot be obtained in some cases. For example, in the first-time processing at steps S132 and S133 (FIG. 2) in an example where C=5, the probability h_{j,c} is uniquely determined as h_{j,0}=0, h_{j,1}=0, h_{j,2}=0, h_{j,3}=1, h_{j,4}=0, and h_{j,5}=0, and each probability a_{k,c,c′} is also uniquely determined as 0 or 1, so that the probability h_{j,c} or a_{k,c,c′} falls into a state of not being updated in iterations thereafter. However, realistically, it is unlikely that the probability h_{j,c} that is “indicators representing degrees of correctness of the individual labels on the data items” and the probability a_{k,c,c′} that is “indicators representing abilities of the raters to correctly assign the labels to the data items” have determinate values such as 0 and 1. Accordingly, in the second embodiment, a variational Bayesian method is used, and the “abilities of the raters to correctly assign the labels to the data items” are defined not as simple probabilities, but as a distribution according to a Dirichlet distribution. Thus, abruptly falling into a local solution is prevented.

<Configuration>

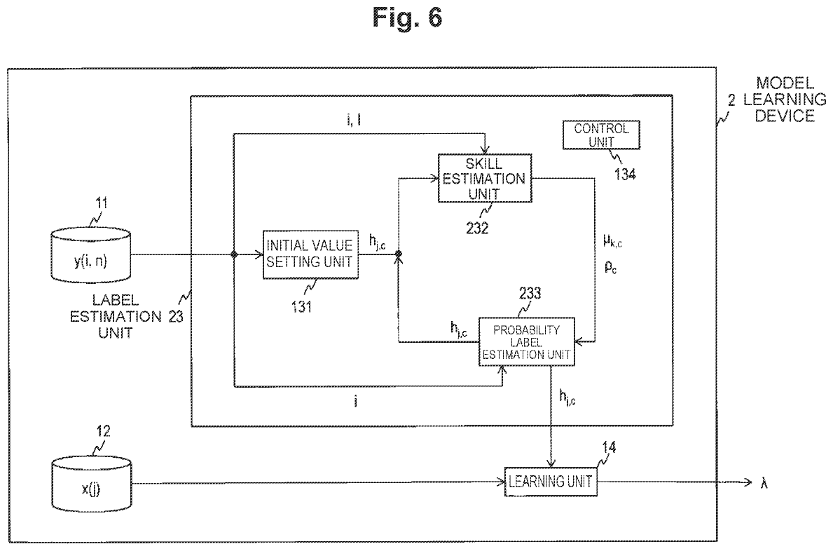

As illustrated in FIG. 6, a model learning device 2 in the present embodiment includes a training label data storage unit 11, a training feature data storage unit 12, a label estimation unit 23, and a learning unit 14. The label estimation unit 23 includes an initial value setting unit 131, a skill estimation unit 232, a label expectation value estimation unit 233, and a control unit 134.

<Preprocessing>

Preprocessing identical to the preprocessing in first embodiment is performed.

<Model Learning Processing>

Next, model learning processing in the present embodiment will be described.

<<Processing by the Label Estimation Unit 23>>

Processing by the label estimation unit 23 of the model learning device 2 (FIG. 6) will be described.

In the present embodiment, a case in which following (2-a) to (2-d) are satisfied will be illustrated as an example. However, such a case does not limit the present invention.

(2-a) Each of the “indicators representing degrees of correctness of the individual labels on the data items” is a probability h_{j,c} that an impression value label c=y(i, 2)∈{0, 1, . . . , C} on a data number j=y(i, 0)∈{0, 1, . . . , J} is a true label (correct impression value label) (a probability that each label c on a data item j is a true label).

(2-b) Each of the “indicators representing abilities of the raters to correctly assign the labels to the data items” is a Dirichlet distribution parameter μ_{k,c} specifying a probability distribution that represents degrees at which a rater with a rater number k∈{0, 1, . . . , K} can correctly assign a label to information (human perceptible information; for example, voice) with a data number j∈{0, 1, . . . , J} whose true impression value label is c∈{0, 1, . . . , C} (a probability distribution that represents degrees at which a rater k can correctly assign a label to a data item j with a true label c).

(2-c) The “first processing” is processing of updating the parameter μ_{k,c} and a Dirichlet distribution parameter ρ specifying a probability distribution for the distribution q_{c} of each label c∈{0, 1, . . . , C}, by using the probability h_{j,c}.

(2-d) The “second processing” is processing of updating the probability h_{j,c}, by using the parameter μ_{k,c} and the parameter ρ.

The label estimation unit 23 in the example estimates the parameters μ_{k,c} and ρ and estimates the probability alternately through the variational Bayesian method, and, with respect to each j∈{0, 1, . . . , J} and each c∈{0, 1, . . . , C}, outputs the optimum probability h_{j,c} as label expectation values to the learning unit 14.

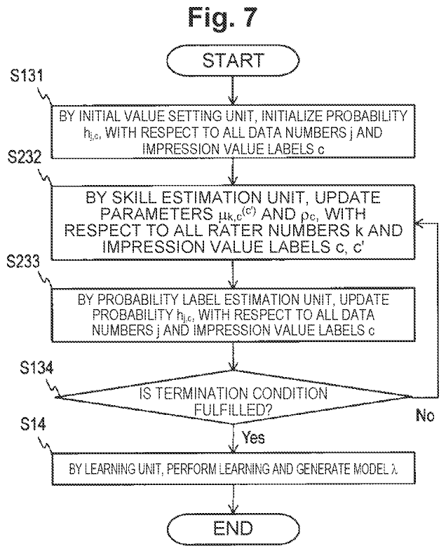

Details of the processing by the label estimation unit 23 will be illustrated by using FIG. 7.

<<Step S131>>

The initial value setting unit 131 (FIG. 6) of the label estimation unit 23 sets initial values of (initializes) the probability h_{j,c} and outputs the initial values of the probability h_{j,c}, by performing the processing in step S131 described in the first embodiment. The initial values of the probability h_{j,c} outputted from the initial value setting unit 131 are transmitted to the skill estimation unit 232.

<<Step S232>>

The skill estimation unit 232 updates the parameter μ_{k,c} and the parameter ρ specifying the probability distribution for the distribution q_{c} of each impression value label c∈{0, 1, . . . , C}, by using the probability h_{j,c}. Details are described below.

A probability distribution a_{k,c} that represents degrees at which a rater with a rater number k∈{0, 1, . . . , K} can correctly assign a label to information (human perceptible information; for example, voice) with a data number j∈{0, 1, . . . , J} whose true impression value label is c∈{0, 1, . . . , C} is given according to the Dirichlet distribution, as in Expression (7) below.

$$\begin{matrix}[ Math . 7 ] & \\ {a}_{k , c} \text{∼} Dirichlet ( {a}_{k , c} \vert {μ}_{k , c} ) = \frac{Γ ( {\sum }_{{c}^{′} = 0}^{C} {μ}_{k , c}^{( {c}^{′} )} )}{{\prod }_{{c}^{′} = 0}^{C} Γ ( {μ}_{k , c}^{( {c}^{′} )} )} {\prod }_{{c}^{′} = 0}^{C} {a}_{k , c , {c}^{′}}^{{μ}_{k , c}^{( {c}^{′} )} - 1} & ( 7 )\end{matrix}$$

where μ_{k,c} is a Dirichlet distribution parameter as follows.

[Math. 8]

μ_{K,C}=(μ_{K,C}⁽⁰⁾,μ_{K,C}⁽¹⁾, . . . ,μ_{K,C}^{(c′)}, . . . ,μ_{K,C}^{(C)})

The probability distribution a_{k,c} is a distribution as follows. μ^{(c′)}_{k,c} is a real number equal to or larger than zero.

[Math. 9]

a_{k,c}=(a_{k,c,0},a_{k,c,1}, . . . ,a_{k,c,c′}, . . . ,a_{k,c,C})

where a_{k,c,c′} represents a probability that a rater with a rater number k∈{0, 1, . . . , K} assigns an impression value label c′∈{0, 1, . . . , C} to information (human perceptible information; for example, voice) with a data number j∈{0, 1, . . . , J} whose true impression value label is c∈{0, 1, . . . , C}. a_{k,c,c′} is a real number that is not smaller than zero and not larger than one, and satisfies a following relationship.

$$\begin{matrix}[ Math . 10 ] & \\ {\sum }_{{c}^{′} = 0}^{C} {a}_{k , c , {c}^{′}} = 1 & \end{matrix}$$

Additionally, Γ is a gamma function.

Based on the foregoing, the skill estimation unit 232 receives the newest probability h_{j,c} as input and, with respect to all rater numbers k∈{0, 1, . . . , K} and all impression value labels c, c′∈{0, 1, . . . , C}, updates the Dirichlet distribution parameter μ_{k,c} that specifies the probability distribution a_{k,c} in accordance with Expression (7), as in Expression (8) below.

$$\begin{matrix}[ Math . 11 ] & \\ {μ}_{k , c}^{( {c}^{′} )} ← {μ}_{k , c}^{( {c}^{′} )} + {\sum }_{i ∈ A (* , k , {c}^{′} )} {h}_{y ( i , 0 ) , c} & ( 8 )\end{matrix}$$

In other words, the skill estimation unit 232 obtains the right side of Expression (8) as a new μ^{(c′)}_{k,c}. Although an initial value of μ^{(c′)}_{k,c} is not limited, the initial value of μ^{(c′)}_{k, c} is set as, for example, μ^{(c′)}_{k,c}=1. Note that a subscript “k,c” in “μ^{(c′)}_{k,c}” would have been written in situ directly under “(c′)” as in Expression (8), but is written right under “(c′)” due to presentation constraints in some cases.

Similarly, the probability distribution q for the distribution q_{c} of all impression value labels c∈{0, 1, . . . , C} is given according to the Dirichlet distribution, as in Expression (9) below.

$$\begin{matrix}[ Math . 12 ] & \\ q \text{∼} Dirichlet ( q \vert ρ ) = \frac{Γ ( {\sum }_{c = 0}^{C} {ρ}_{c} )}{{\prod }_{c = 0}^{C} Γ ( {ρ}_{c} )} {\prod }_{c = 0}^{C} {q}_{c}^{{ρ}_{c} - 1} & ( 9 )\end{matrix}$$

where q is a parameter q=(q₀, q₁, . . . , q_{c}′, q_{C}), and ρ is a Dirichlet distribution parameter ρ=(ρ₀, ρ₁, . . . , ρ_{c′}, . . . , ρ_{C}). q_{c′} and ρ_{c′} are positive real numbers.

Based on the foregoing, the skill estimation unit 232 receives the newest probability h_{j,c} as input and, with respect to all impression value labels c∈{0, 1, . . . , C}, updates the Dirichlet distribution parameter ρ_{c} as in Expression (10) below.

$$\begin{matrix}[ Math . 13 ] & \\ {ρ}_{c} ← {ρ}_{c} + {\sum }_{i ∈ A (* , * , c )} {h}_{y ( i , 0 ) , c} & ( 10 )\end{matrix}$$

In other words, the skill estimation unit 232 obtains the right side of Expression (10) as a new Dirichlet distribution parameter ρ_{c}. Although an initial value of ρ_{c} is not limited, the initial value of ρ_{c} is set as, for example, ρ_{c}=1.

The new μ_{k,c} and ρ updated by the skill estimation unit 232 are transmitted to the label expectation value estimation unit 233.

<<Step S233>>

The label expectation value estimation unit 233 receives the newest parameter μ_{k,c} and the newest parameter ρ as input and, by using the parameters, estimates (updates) and outputs the probability h_{j,c} as in Expressions (11) and (12) below.

$$\begin{matrix} [ Math . 14 ] & \\ {Q}_{j , c} = exp \{ Ψ ( {ρ}_{c} ) - Ψ ( {\sum }_{{c}^{′} = 0}^{C} {ρ}_{{c}^{′}} ) + {\sum }_{i ∈ A ( j , * , c )} ( Ψ ( {μ}_{y ( i , 1 ) , c}^{( y ( i , 2 ) )} ) - Ψ ( {\sum }_{{c}^{′} = 0}^{C} {μ}_{y ( i , 1 ) , c}^{( {c}^{′} )} ) ) \} & ( 11 ) \\ [ Math . 15 ] & \\ {h}_{j , c} = \frac{{Q}_{j , c}}{{\sum }_{{c}^{′} = 0}^{C} {Q}_{j , {c}^{′}}} & ( 12 )\end{matrix}$$

where ψ is a digamma function and represents an inverse function of a gamma function. The new probability h_{j,c} updated by the label expectation value estimation unit 233 is transmitted to the skill estimation unit 232.

<<Step S134>>

As described in the first embodiment, the control unit 134 determines whether or not a termination condition is fulfilled. When it is determined that the termination condition is not fulfilled, the processing returns to step S132. When it is determined that the termination condition is fulfilled, the label expectation value estimation unit 133 outputs the newest probability h_{j,c} as label expectation values to the learning unit 14, and the learning unit 14 performs the processing in step S14 described in the first embodiment. Processing by the learning unit 14 and estimation processing by the label estimation device 15 performed thereafter are as described in the first embodiment.

[Experimental Data]

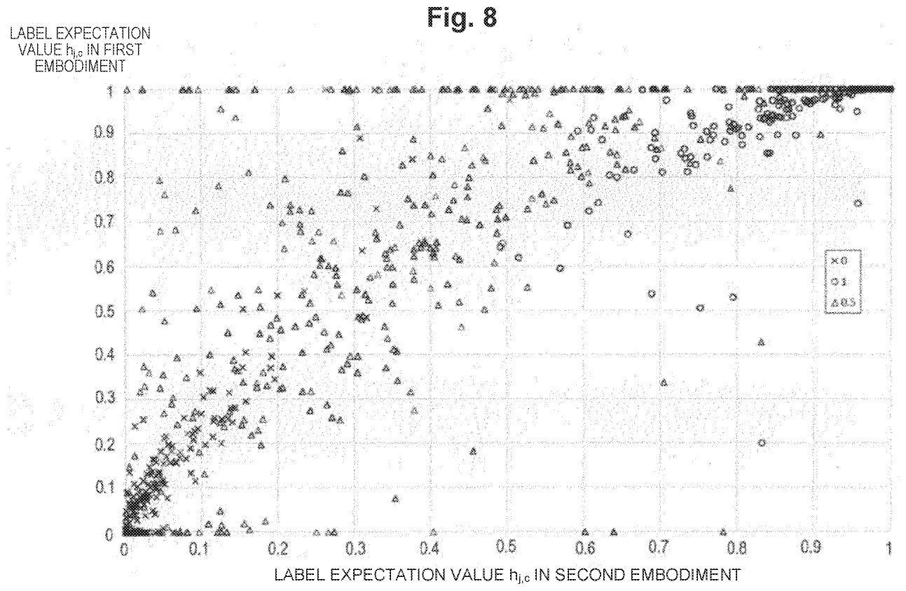

FIG. 8 is a diagram illustrating label expectation values h_{j,c} (probability h_{j,c} that an impression value label c∈{0, 1} on a data number j∈{0, 1, . . . , 268} is a true label) obtained by the methods in the first and second embodiments, using training label data obtained in such a manner that with 269 raters in total, two raters per voice corresponding to a data number y(i, 0) rate an impression of the voice on a binary scale of “high/low”, and assign binary impression value labels y(i, 2)∈{0, 1} representing results of the rating. An impression value label c with a value closer to one indicates that the impression is “high”, and an impression value label c with a value closer to zero indicates that the impression is “low”. Values on a vertical axis represent label expectation values (probability) h_{j,c} estimated by the method in the first embodiment (EM algorithm), and values on a horizontal axis represent label expectation values (probability) h_{j,c} estimated by the method in the second embodiment (variational Tayesian method). In the drawing, a mark x represents an event in which both of the two raters have an impression of “low” about, that is, assign the impression value label c=0 to, a voice corresponding to the data number y(i, 0). A mark ◯ represents an event in which both of the two raters have an impression of “high” about, that is, assign the impression value label c=1 to, a voice corresponding to the data number y(i, 0). A mark Δ represents an event in which the two raters have different impressions about a voice corresponding to the data number y(i, 0), that is, an event in which one rater assigns the impression value label c=0, and the other rater assigns the impression value label c=1. As can be seen from the drawing, there are more events at a value of zero or one on the horizontal axis, and it can be understood that many of the label expectation values h_{j,c} estimated by the method in the first embodiment (EM algorithm) converge to local solutions of one or zero. On the other hand, there are a smaller number of events at a value of zero or one on the vertical axis, and it can be understood that the label expectation values h_{j,c} estimated by the method in the second embodiment (variational Bayesian method) converge to local solutions less frequently, and that the label expectation values h_{j,c} are distributed widely across a range between zero and one.

### Other Modification Examples and the Like

The present invention is not limited to the above-described embodiments. For example, in the first embodiment, the initial value setting unit 131 sets initial values of the probability h_{j,c} (step S131), and it is iterated that the skill estimation unit 132 performs the processing of updating the probability a_{k,c,c′} and the distribution q_{c} by using the probability h_{j,c} (step S132) and then the label expectation value estimation unit 133 performs the processing of updating the probability h_{j,c} by using the probability a_{k,c,c′} and the distribution q_{c} (step S133). Although such order is optimum, the order of the processing by the skill estimation unit 132 and the processing by the label expectation value estimation unit 133 may be interchanged. In other words, the initial value setting unit 131 sets initial values of the probability a_{k,c,c′} and the distribution q_{c}, and it may be iterated that the label expectation value estimation unit 133 performs the processing of updating the probability by using the probability a_{k,c,c′} and the distribution q_{c} (step S133) and then the skill estimation unit 132 performs the processing of updating the probability a_{k,c,c′} and the distribution q_{c} by using the probability h_{j,c} (step S132). In such a case, the newest probability h_{j,c} may also be obtained as label expectation values h_{j,c} when the termination condition is fulfilled. For the initial values of the probability a_{k,c,c′}, a value (a value that is not smaller than zero and not larger than one) can be cited as an example that becomes larger as a larger number of other raters assign, to “human perceptible information (voice or the like)” with a data number j, a label c′ having the same rating value as an impression value label c′ assigned by a rater with a rater number k to the “human perceptible information (voice or the like)” with the same data number j. For the initial value of the distribution q_{c}, “1” can be cited as an example.

Similarly, in the second embodiment, the initial value setting unit 131 sets initial values of the probability h_{j,c} (step S131), and it is iterated that the skill estimation unit 232 performs the processing of updating the parameter μ_{k,c} and the parameter ρ by using the probability h_{j,c} (step S232) and then the label expectation value estimation unit 233 performs the processing of updating the probability h_{j,c} by using the parameter μ_{k,c} and the parameter ρ (step S233). Although such order is optimum, the order of the processing by the skill estimation unit 232 and the processing by the label expectation value estimation unit. 233 may be interchanged. In other words, the initial value setting unit 131 sets initial values of the parameter μ_{k,c} and the parameter ρ, and it may be iterated that the label expectation value estimation unit 233 performs the processing of updating the probability h_{j,c} by using the parameter μ_{k,c} and the parameter ρ (step S233) and then the skill estimation unit 232 performs the processing of updating the parameter μ_{k,c}, and the parameter ρ by using the probability h_{j,c} (step S232). In such a case, the newest probability h_{j,c} may also be obtained as label expectation values h_{j,c} when the termination condition is fulfilled.

In addition, in place of the label expectation values obtained by the label estimation unit 13, 23 in the first, second embodiment, label expectation values h_{j,c} obtained by a different method from the label estimation unit 13, 23 or label expectation values h_{j,c} externally inputted may be inputted into the learning unit 14, and the processing in step S14 described above may be performed.

The above-described various processing is not only performed in a time sequence by following the description, but may also be performed in parallel, or individually, depending on throughput of a device that performs the processing, or as necessary. In addition, it goes without saying that changes can be made as appropriate without departing from the scope of the present invention.

Each device described above is configured, for example, in such a manner that a general-purpose or dedicated computer including a processor (hardware processor) such as a CPU (central processing unit), a memory such as a RAN (random-access memory) or a ROM (read-only memory), and the like executes a predetermined program. The computer may include a single processor and a single memory, or may include a plurality of processors and a plurality of memories. The program may be installed in the computer, or may be recorded beforehand in the ROM or the like. A portion or all of the processing units may be configured, not by using electronic circuitry that implements the functional components by reading the program like a CPU, but by using electronic circuitry that implements the processing functions without using the program. Electronic circuitry included in one device may include a plurality of CPUs.

When the above-described configuration is implemented by a computer, contents of the processing by the functions to be included in each device are described by a program. The program is executed by the computer, whereby the above-described processing functions are implemented on the computer. The program that describes the contents of the processing can be recorded in a computer-readable recording medium. An example of the computer-readable recording medium is a non-transitory recording medium. Examples of such a recording medium include a magnetic recording device, an optical disk, a magneto-optical recording medium, a semiconductor memory, and the like.

Distribution of the program is performed, for example, by sale, transfer, lease, and the like of a removable recording medium such as a DVD or a CD-ROM in which the program is recorded. Moreover, distribution of the program may be configured to be performed in such a manner that the program is stored in a storage device of a server computer and the program is transferred from the server computer to another computer via a network.

The computer that executes such a program, for example, first stores the program stored in the removable recording medium or the program transferred from the server computer in an own storage device on one occasion. When performing processing, the computer reads the program stored in the own storage device, and performs processing according to the read program. As another mode of executing the program, the computer may directly read the program from the removable recording medium, and perform processing according to the program, or further, each time the program is transferred from the server computer to the computer, the computer may sequentially perform processing according to the received program. A configuration may also be made such that, without transferring the program from the server computer to the computer, the above-described processing is performed through a so-called ASP (Application Service Provider) service in which the processing functions are implemented only by execution instructions and acquisition of results.

At least a portion of the processing functions of the devices may be implemented by hardware, not that the processing functions are implemented by running the predetermined program on the computer.

### REFERENCE SIGNS LIST

1, 2 Model learning device
15 Label estimation device

1. A model learning device, comprising:
a learner configured to perform learning processing in which a plurality of data items and label expectation values that are indicators representing degrees of correctness of individual labels on the data items are used in pairs as training data; and
an obtainer configured to obtain a model that estimates a label on an input data item.

2. The model learning device according to claim 1, wherein the label expectation values are the indicators representing degrees of correctness of the individual labels on the data items, the indicators obtained by:
receiving, as input, information representing labels assigned by a plurality of raters, respectively, to each of the plurality of data items, and
alternately iterating:
first processing of updating indicators representing abilities of the raters to correctly assign the labels to the data items, while the indicators representing degrees of correctness of the individual labels on the data items are regarded as known, and
second processing of updating the indicators representing degrees of correctness of the individual labels on the data items, while the indicators representing abilities of the raters to correctly assign the labels to the data items are regarded as known.

3. The model learning device according to claim 2,
wherein each of the indicators representing degrees of correctness of the individual labels on the data items is a probability h_{j,c} that a label c of the individual labels on a data item j of the data items is a true label,
wherein each of the indicators representing abilities of the raters to correctly assign the labels to the data items is a probability a_{k,c,c′} that a rater k of the raters assigns a label c′ to the data item j with the true label c;
wherein the first processing is processing of updating the probability a_{k,c,c′} and a distribution q_{c} of the individual labels c, by using the probability h_{j,c}; and
wherein the second processing is processing of updating the probability h_{j,c}, by using the probability a_{k,c,c′}, and the distribution q_{c}.

4. A label estimation device,
a learner configured to perform learning processing in which a plurality of data items and label expectation values that are indicators representing degrees of correctness of individual labels on the data items are used in pairs as training data;
an obtainer configured to obtain a model that estimates a label on an input data item;
an applier configured to apply an input data item to the model; and
an estimator configured to estimate a label on the input data item.

5. A method, comprising:
performing, by a learner, learning processing in which a plurality of data items and label expectation values that are indicators representing degrees of correctness of individual labels on the data items are used in pairs as training data; and
obtaining, by an obtainer, a model that estimate a label on an input data item.

6. The method according to claim 5, the method further comprising:
applying, by an applier, an input data item to the model; and
estimating, by an estimator, a label on the input data item.

7.-8. (canceled)

9. The model learning device according to claim 2,
wherein each of the indicators representing degrees of correctness of the individual labels on the data items is a probability h_{j,c} that a label c of the individual labels on a data item j of the data items is a true label;
wherein each of the indicators representing abilities of the raters to correctly assign the labels to the data items is a parameter μ_{k,c} specifying a probability distribution that represents degrees at which a rater k of the raters can correctly assign a label to the data item j with the true label c;
wherein the first processing is processing of updating the parameter μ_{k,c} and a parameter ρ specifying a probability distribution for a distribution q_{c} of the individual labels c, by using the probability h_{j,c}; and
wherein the second processing is processing of updating the probability h_{j,c}, by using the parameter μ_{k,c} and the parameter ρ.

10. The model learning device according to claim 2, wherein the model is a neural network model, and wherein the learner learns by minimizing a cross-entropy loss that includes an estimation value of the neural network model.

11. The label estimation device according to claim 4, wherein the label expectation values are the indicators representing degrees of correctness of the individual labels on the data items, the indicators obtained by:
receiving, as input, information representing labels assigned by a plurality of raters, respectively, to each of the plurality of data items, and
alternately iterating:
first processing of updating indicators representing abilities of the raters to correctly assign the labels to the data items, while the indicators representing degrees of correctness of the individual labels on the data items are regarded as known, and
second processing of updating the indicators representing degrees of correctness of the individual labels on the data items, while the indicators representing abilities of the raters to correctly assign the labels to the data items are regarded as known.

12. The method according to claim 5, wherein the label expectation values are the indicators representing degrees of correctness of the individual labels on the data items, the indicators obtained by:
receiving, as input, information representing labels assigned by a plurality of raters, respectively, to each of the plurality of data items, and
alternately iterating:
first processing of updating indicators representing abilities of the raters to correctly assign the labels to the data items, while the indicators representing degrees of correctness of the individual labels on the data items are regarded as known, and
second processing of updating the indicators representing degrees of correctness of the individual labels on the data items, while the indicators representing abilities of the raters to correctly assign the labels to the data items are regarded as known.

13. The method according to claim 6, wherein the label expectation values are the indicators representing degrees of correctness of the individual labels on the data items, the indicators obtained by:
receiving, as input, information representing labels assigned by a plurality of raters, respectively, to each of the plurality of data items, and
alternately iterating:
first processing of updating indicators representing abilities of the raters to correctly assign the labels to the data items, while the indicators representing degrees of correctness of the individual labels on the data items are regarded as known, and
second processing of updating the indicators representing degrees of correctness of the individual labels on the data items, while the indicators representing abilities of the raters to correctly assign the labels to the data items are regarded as known.

14. The label estimation device according to claim 11, wherein each of the indicators representing degrees of correctness of the individual labels on the data items is a probability h_{j,c} that a label c of the individual labels on a data item j of the data items is a true label,
wherein each of the indicators representing abilities of the raters to correctly assign the labels to the data items is a probability a_{k,c,c′} that a rater k of the raters assigns a label c′ to the data item j with the true label c;
wherein the first processing is processing of updating the probability a_{k,c,c′} and a distribution q_{c} of the individual labels c, by using the probability h_{j,c}; and
wherein the second processing is processing of updating the probability h_{j,c}, by using the probability a_{k,c,c′}, and the distribution q_{c}.

15. The label estimation device according to claim 11, wherein each of the indicators representing degrees of correctness of the individual labels on the data items is a probability h_{j,c} that a label c of the individual labels on a data item j of the data items is a true label;
wherein each of the indicators representing abilities of the raters to correctly assign the labels to the data items is a parameter μ_{k,c} specifying a probability distribution that represents degrees at which a rater k of the raters can correctly assign a label to the data item j with the true label c;
wherein the first processing is processing of updating the parameter μ_{k,c} and a parameter ρ specifying a probability distribution for a distribution q_{c} of the individual labels c, by using the probability h_{j,c}; and
wherein the second processing is processing of updating the probability h_{j,c}, by using the parameter μ_{k,c} and the parameter ρ.

16. The label estimation device according to claim 11, wherein the model is a neural network model, and wherein the learner learns by minimizing a cross-entropy loss that includes an estimation value of the neural network model.

17. The method according to claim 12, wherein each of the indicators representing degrees of correctness of the individual labels on the data items is a probability h_{j,c} that a label c of the individual labels on a data item j of the data items is a true label,
wherein each of the indicators representing abilities of the raters to correctly assign the labels to the data items is a probability a_{k,c,c′} that a rater k of the raters assigns a label c′ to the data item j with the true label c;
wherein the first processing is processing of updating the probability a_{k,c,c′} and a distribution q_{c} of the individual labels c, by using the probability h_{j,c}; and
wherein the second processing is processing of updating the probability h_{j,c}, by using the probability a_{k,c,c′} and the distribution q_{c}.

18. The method according to claim 12, wherein each of the indicators representing degrees of correctness of the individual labels on the data items is a probability h_{j,c} that a label c of the individual labels on a data item j of the data items is a true label;
wherein each of the indicators representing abilities of the raters to correctly assign the labels to the data items is a parameter μ_{k,c} specifying a probability distribution that represents degrees at which a rater k of the raters can correctly assign a label to the data item j with the true label c;
wherein the first processing is processing of updating the parameter μ_{k,c} and a parameter ρ specifying a probability distribution for a distribution q_{c} of the individual labels c, by using the probability h_{j,c}; and
wherein the second processing is processing of updating the probability h_{j,c} by using the parameter μ_{k,c} and the parameter 92.

19. The method according to claim 12, wherein the model is a neural network model, and wherein the learner learns by minimizing a cross-entropy loss that includes an estimation value of the neural network model.

20. The method according to claim 13, wherein each of the indicators representing degrees of correctness of the individual labels on the data items is a probability h_{j,c} that a label c of the individual labels on a data item j of the data items is a true label,
wherein each of the indicators representing abilities of the raters to correctly assign the labels to the data items is a probability a_{k,c,c′} that a rater k of the raters assigns a label c′ to the data item j with the true label c;
wherein the first processing is processing of updating the probability a_{k,c,c′} and a distribution q_{c} of the individual labels c, by using the probability h_{j,c}; and
wherein the second processing is processing of updating the probability h_{j,c}, by using the probability a_{k,c,c′} and the distribution q_{c}.

21. The method according to claim 13, wherein each of the indicators representing degrees of correctness of the individual labels on the data items is a probability h_{j,c} that a label c of the individual labels on a data item j of the data items is a true label;
wherein each of the indicators representing abilities of the raters to correctly assign the labels to the data items is a parameter μ_{k,c} specifying a probability distribution that represents degrees at which a rater k of the raters can correctly assign a label to the data item j with the true label c;
wherein the first processing is processing of updating the parameter μ_{k,c} and a parameter ρ specifying a probability distribution for a distribution q_{c} of the individual labels c, by using the probability h_{j,c}; and
wherein the second processing is processing of updating the probability h_{j,c}, by using the parameter μ_{k,c} and the parameter μ.

22. The method according to claim 13, wherein the model is a neural network model, and wherein the learner learns by minimizing a cross-entropy loss that includes an estimation value of the neural network model.
